(19) United States
(12) Patent Application Publication
(10) Pub. No.: US 2019/0323467 A1
(43) Pub. Date: Oct. 24, 2019

(54) SYSTEMS AND METHODS FOR A SOLENOID HAVING A DIMPLED ARMATURE TUBE

(71) Applicant: HUSCO Automotive Holdings LLC, WAUKESHA, WI (US)

(72) Inventor: AUSTIN SCHMITT, Hartland, WI (US)

(21) Appl. No.: 16/389,010

(22) Filed: Apr. 19, 2019

Related U.S. Application Data
(60) Provisional application No. 62/660,132, filed on Apr. 19, 2018.

(51) Int. Cl. F02M 61/16; F02M 51/06; F16K 27/04; F16K 31/06

(52) U.S. Cl. CPC F02M 61/168; F16K 31/0675; F16K 27/048; F02M 51/0682

(57) ABSTRACT

In one aspect, a solenoid tube for a solenoid is provided. The solenoid tube includes a unitary body, an inner surface on the unitary body, and a plurality of dimples formed on the inner surface. The unitary body defines a generally cylindrical shape and includes a first end and a second end. The inner surface extends between the first open end and the second closed end. The plurality of dimples extend radially inward from the inner surface of the unitary body.

### CROSS-REFERENCES TO RELATED APPLICATIONS

The present application is based on, claims priority to, and incorporates herein by references in its entirety U.S. Provisional Patent Application No. 62/660,132, filed on Apr. 19, 2018, the entire disclosure of which is incorporated herein by reference in its entirety.

### STATEMENT REGARDING FEDERALLY SPONSORED RESEARCH

Not Applicable.

### BACKGROUND

In general, solenoids include a moveable armature arranged within a housing. In some configurations, the armature may be slidably arranged within an armature tube.

### BRIEF SUMMARY

In one aspect, the present disclosure provides a solenoid including a housing, a wire coil arranged within the housing, and an armature tube having an inner tube surface and a plurality of dimples extending radially inward from the inner surface and arranged circumferentially around the inner tube surface. The solenoid further includes an armature slidably arranged within the armature tube. The armature is centered within the armature tube by engagement with the plurality of dimples.

In one aspect, the present disclosure provides a solenoid tube for a solenoid. The solenoid tube includes a unitary tube body defining a generally cylindrical shape and having a first end and a second end, an inner tube surface on the unitary tube body and extending between the first end and the second end and a plurality of dimples formed on the inner surface and extending radially inward therefrom.

In one aspect, the present disclosure provides a solenoid including a housing, a wire coil arranged within the housing, an armature tube arranged at least partially within the housing, and an armature slidably arranged within the armature tube. The solenoid further includes a first alignment ring coupled to the armature and having a first plurality of dimples extending radially outward therefrom, and a second alignment ring coupled to the armature and axially separated from the first alignment ring. The second alignment member includes a second plurality of dimples extending radially outward therefrom. The armature is centered within the armature tube by engagement with the first plurality of dimples and the second plurality of dimples.

In one aspect, the present disclosure provides a armature for a solenoid. The armature includes a unitary armature body defining a generally cylindrical shape and having a first end and a second end, a first radially recessed portion formed in the unitary armature body adjacent to the first end, and a second radially recessed portion formed in the unitary armature body adjacent to the second end. The armature further includes a first alignment ring arranged within the first radially recessed portion and having a first plurality of dimples extending radially outward therefrom, and a second alignment ring arranged within the second radially recessed portion and having a second plurality of dimples extending radially outward therefrom.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic illustration of a solenoid according to one aspect of the present disclosure.

FIG. 2 is a perspective view of a armature tube according to one aspect of the present disclosure.

FIG. 3 is a perspective view of a armature tube having offset dimples according to one aspect of the present disclosure.

FIG. 4 is a cross-sectional view of the armature tube of FIG. 3 taken along line 4-4.

FIG. 5 is a cross-section view of the armature tube of FIG. 3 taken along line 5-5 in FIG. 4.

FIG. 6 is an enlarged view of section 6-6 in FIG. 5

FIG. 7 is a perspective view of an armature tube according to one aspect of the present disclosure.

FIG. 8 is a cross-sectional view of the armature tube of FIG. 7 taken along line 8-8.

FIG. 9 is an enlarged view of dimples arranged on an inner surface of the armature tube of FIG. 7.

FIG. 10 is a perspective view of an armature tube according to one aspect of the present disclosure.

FIG. 11 is a cross-sectional view of the armature tube of FIG. 10 taken along line 11-11.

FIG. 12 is a perspective view of an armature tube according to one aspect of the present disclosure.

FIG. 13 is a cross-sectional view of the armature tube of FIG. 12 taken along line 13-13.

FIG. 14 is a top view of a solenoid including the armature tube of FIG. 7 according to one aspect of the present disclosure.

FIG. 15 is a cross-sectional view of the solenoid of FIG. 14 taken along line 15-15.

FIG. 16 is an enlarged view of section 16-16 in FIG. 15.

FIG. 17 is a perspective view of an armature according to one aspect of the present disclosure.

FIG. 18 is a cross-sectional view of the armature of FIG. 17 taken along line 18-18.

FIG. 19 is a perspective view of an armature having collars with fingers according to one aspect of the present disclosure.

FIG. 20 is an exploded view of the armature of FIG. 19.

FIG. 21 is a cross-sectional view of the armature of FIG. 19 taken along line 21-21.

FIG. 22 is a perspective view of an armature having alignment features on a collar according to one aspect of the present disclosure.

FIG. 23 is perspective view of an armature having a metal alignment ring within a recessed notch according to one aspect of the present disclosure.

FIG. 24 is a perspective view of an armature having a metal alignment ring secured with a collar according to one aspect of the present disclosure.

FIG. 25 is a perspective view of an armature having a metal alignment ring secured with a collar having fingers according to one aspect of the present disclosure.

FIG. 26 is a perspective view of a metal alignment ring according to one aspect of the present disclosure.

### DETAILED DESCRIPTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use herein of the term “axial” and variations thereof refers to a direction that extends generally along an axis of symmetry, a central axis, or an elongate direction of a particular component or system. For example, axially extending features of a component may be features that extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference of an object or around an axis of symmetry, a central axis or an elongate direction of a particular component or system.

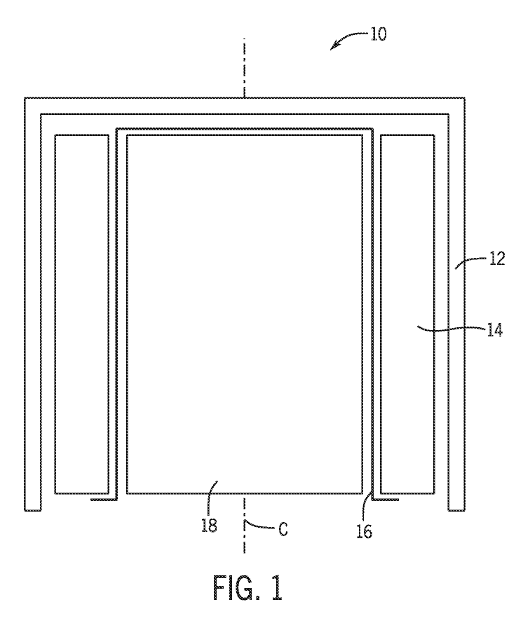

FIG. 1 illustrates one non-limiting example of a solenoid 10 according to the present disclosure. The solenoid 10 may include a housing 12, a wire coil 14, an armature tube 16, and an armature 18. The wire coil 14 may be arranged within the housing 12 and may be selectively energized (i.e., supplied with a current at a predetermined magnitude in a desired direction), for example, by an external controller (not shown). The armature tube 16 may be at least partially arranged within the housing 12. The armature 18 may be slidably arranged within the armature tube 16. In some non-limiting examples, the housing 12, the wire coil 14, the armature tube 16, and the armature 18 may be arranged along a common central axis C.

In operation, the wire coil 14 may be selectively energized to generate a magnetic field in a direction that corresponds with the direction of current applied thereto. The magnetic field generated by the wire coil 14 may apply a force to the armature 18 and the armature 18 may then actuate (i.e., displace) in a desired direction.

Generally, the armature tube 16 may provide a cavity within which the armature 18 may slidably actuate. Conventional solenoids may include an armature having a plurality of radially recessed slots arranged circumferentially around a periphery of the armature that extend axially therealong. A plurality of ball bearings may be arranged within the radially recessed slots that are configured to engage an inner surface of the armature tube. In these conventional armature designs, several components may influence the assembly and performance of the solenoid. For example, the concentricity of the armature within the armature tube may be influenced by the radial depth of the bearing slots and/or the diameter of the individual bearings. In addition, the clearance, or radial air gap, between the armature and the armature tube may be influenced by the manufacturing tolerances associated with the radial depth of the bearing slots and/or the diameter of the individual bearings.

The use of ball bearings and bearing slots in conventional solenoid designs also make the armature difficult to manufacture. For example, the armature may need to be manufactured using a powder metal process, which requires more post processing and inspection, and reduces a density of the armature thereby reducing its magnetic capacitance.

In general, the present disclosure provides a solenoid that includes an armature tube and an armature that may be efficiently manufactured, while maintaining the magnetic capacitance of the armature. For example, the armature and/or the armature tube may include alignment features that do not require the use of ball bearings and the accompanying bearing slots, which significantly simplifies the manufacture and assembly of the solenoid.

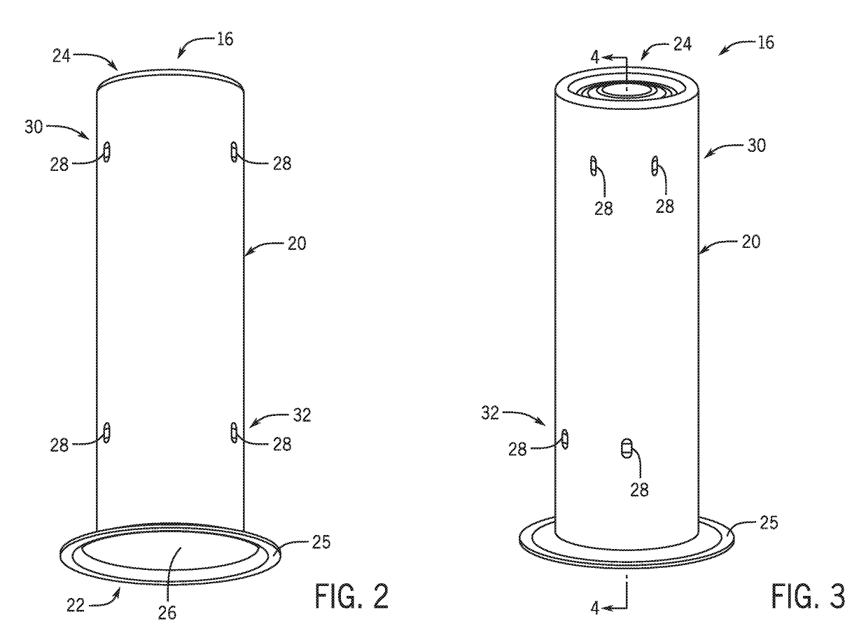

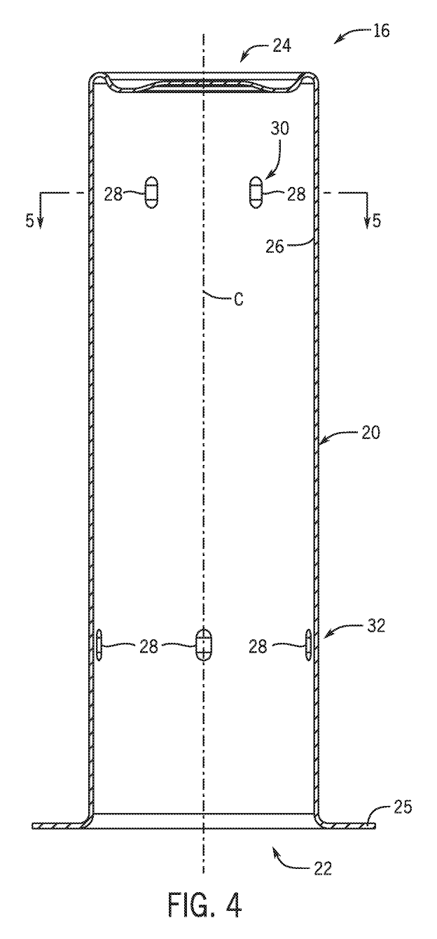

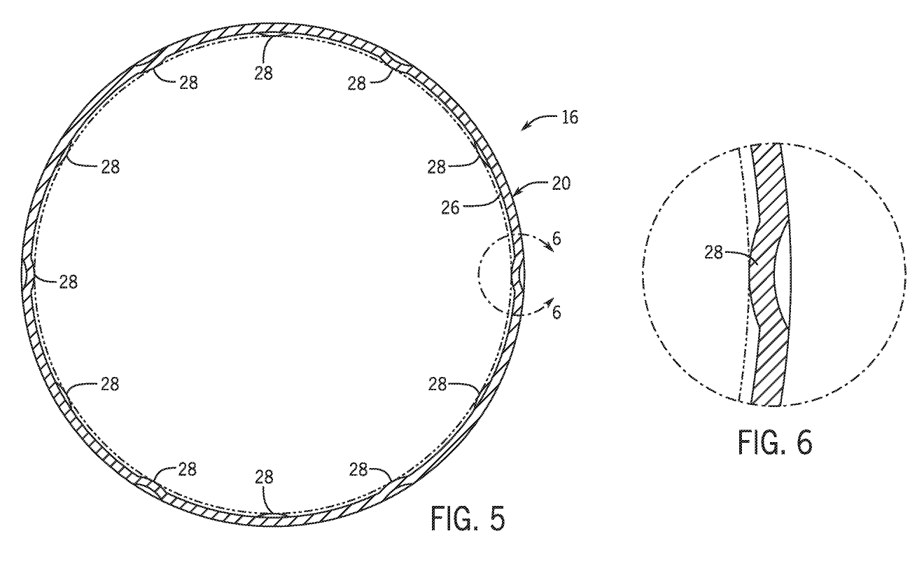

FIG. 2-6 illustrate one non-limiting example of the armature tube 16 that may be implemented within the solenoid 10. In the illustrated non-limiting example, the armature tube 16 includes a unitary (i.e., one-piece) tube body 20 that defines a generally cylindrical shape. The unitary tube body 20 includes a first open end 22 to facilitate insertion of the armature 18 therein and a second closed end 24 axially separated from the first open end 22. A tube flange 25 extends radially outward from the first open end 22. The unitary tube body 20 includes an inner tube surface 26 on which a plurality of dimples 28 are formed. The plurality of dimples 28 extend radially inward from the inner tube surface 26.

In the illustrated non-limiting example, the plurality of dimples 28 include a first set of dimples 30 and a second set of dimples 32 axially separated from the first set of dimples 30. The first set of dimples 30 include a first plurality of axially aligned, circumferentially spaced dimples. The second set of dimples 32 include a second plurality of axially aligned, circumferentially spaced dimples. In some non-limiting examples, the first set of dimples 30 and the second set of dimples 32 may include five dimples equally spaced circumferentially around the inner tube surface 26. In some non-limiting examples, the first set of dimples 30 and the second set of dimples 32 may include more or less than five dimples spaced circumferentially around the inner tube surface 26 in any increment.

In the non-limiting example of FIG. 2, the first set of dimples 30 may be circumferentially aligned with the second set of dimples 32. In the non-limiting example of FIGS. 3-6, the first set of dimples 30 may be circumferentially offset from the second set of dimples 32. In some non-limiting examples, the first set of dimples 30 may include a first sub-set of dimples that are axially offset from a second sub-set of dimples, with both of the first sub-set of dimples and the second sub-set of dimples being axially spaced from the second set of dimples 32. In some non-limiting examples, the second set of dimples 32 may include a first sub-set of dimples that are axially offset from a second sub-set of dimples, with both the first sub-set and the second sub-set being axially spaced from the first set of dimples 30. It should be appreciated that the plurality of dimples 28 may be arranged in various axial and circumferential patterns along the armature tube 16 (e.g., a helical pattern, etc.).

The plurality of dimples 28 may be arranged on the inner tube surface 26 such that axially aligned adjacent pairs of the plurality of dimples 28 are circumferentially spaced to allow contaminants to pass therebetween. In other words, the use of the plurality of dimples 28 provides space between axially aligned adjacent pairs of the plurality of dimples 28 to allow contaminants to be pushed out of the way and around the individual dimples 28, during operation of the solenoid 10 (i.e., during actuation of the armature 18). The gaps between the dimples 28 provide an unobstructed axial path for contaminants to move freely while not impinging the free motion of the armature 18 sliding element on the armature tube 16.

In addition to allowing contaminants to flow around the dimples 28, the dimples 28 may also aid in arranging the armature 18 concentrically within the armature tube 16. That is, when assembled, engagement between the armature 18 and the dimples 28 may center the armature 18 within the armature tube 16. Further, the radial extension of the dimples 28 from the inner tube surface 26 may define a radial air gap or radial clearance between the inner tube surface 26 and an outer surface of the armature 18. That is, a distance that the dimples 28 extend from the inner tube surface 26 inward toward the central axis C may define the radial clearance between the armature 18 and the inner tube surface 26 of the armature tube 16.

During operation, the dimples 28 may provide a low-friction interference with the armature 18 to ensure efficient operation of the solenoid 10. Also, the geometric design of the dimples 28 may provide superior control of the radial clearance between the armature 18 and the inner tube surface 26 and the concentricity of the armature 18 within the armature tube 16, when compared with conventional bearing slots.

In some non-limiting examples, the armature tube 16 may be fabricated from a plastic material, a composite material, a metal material, a magnetic material, and/or a non-magnetic material. In some non-limiting examples, the armature tube 16 may be manufactured via injection molding, a deep draw manufacturing process, machining, rolling, or a forming manufacturing process. In some non-limiting examples, the dimples 28 may be formed in the armature tube 16 using a forming manufacturing process, a molding manufacturing process, or a hydroforming manufacturing process.

In some non-limiting examples, the dimples 28 can define a predefined shape, or profile, to tailor to desired performance characteristics of the solenoid 10. For example, the shape defined by the dimples 28 may determine a contact area between the armature tube 16 and the armature 18. In general, the contact area between the armature tube 16 and the armature 18 can affect the durability and hysteresis of the solenoid. However, durability and hysteresis effects have an inverse relationship. Thus, the contact area (i.e., the shape of the dimples 28) may be designed differently to meet various solenoid applications depending on hysteresis requirements and/or different amounts of side loading. For example, in some applications, it may be desired to minimize the contact area between the armature tube 16 and the armature 18 to improve hysteresis, and one of the armature tube 16 and the armature 18 may be hardened to compensate for durability. In other applications, it may be desired to provide a larger contact area between the armature tube 16 and the armature 18, which may negate the need for hardening.

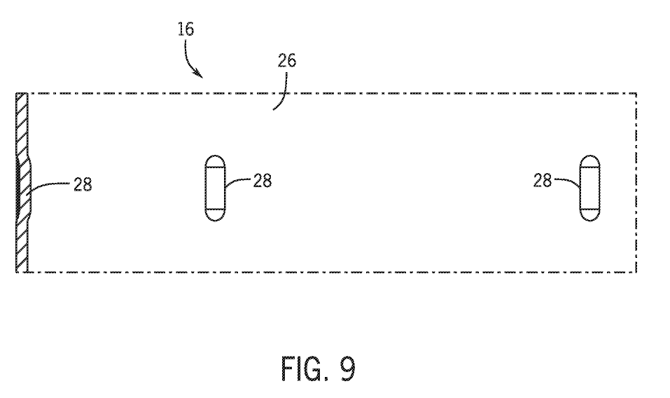

In addition to contact area, the shape of the dimples 28 may determine the ability of the dimples 28 to expunge contaminants, rather than entrap contaminants. For example, if the leading edge (i.e., the axial ends thereof) is flat and wedge shaped, a contaminant would likely become trapped upon engagement with a dimple. For that reason, it is desired that the dimples 28 define a shape that has a high approach angle so that contaminants are likely to get nudged around the dimples 28 rather than trapped by it. In some non-limiting examples, the dimples 28 may be shaped such that the ends thereof are boat-shaped (i.e., formed like the front of a boat) to aid in deflection of contaminants (see, e.g., FIG. 9).

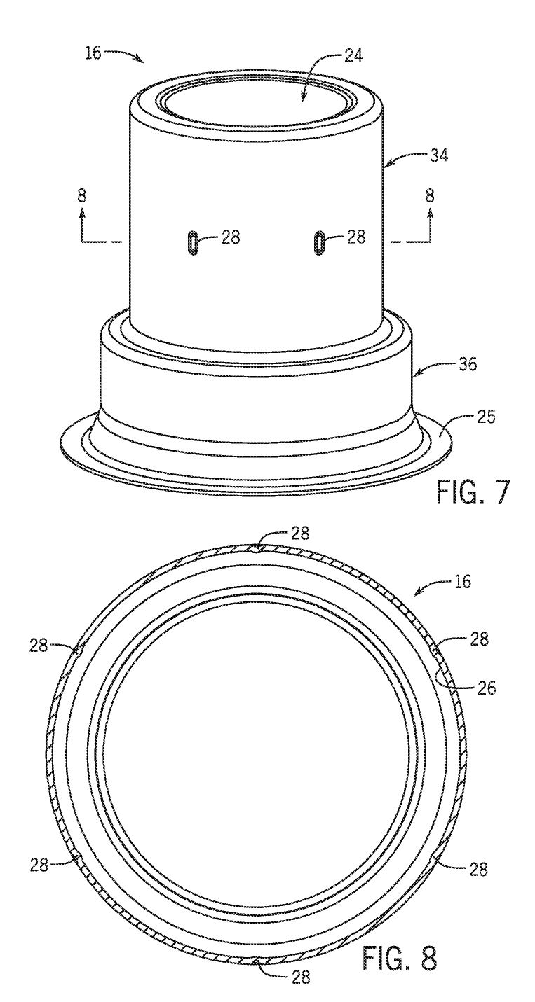

In some non-limiting examples, the armature tube 16 may be shaped to accommodate a pole piece of the solenoid. For example, as illustrated in FIGS. 7-9, the armature tube 16 may defined a stepped outer profiled to facilitate a pole piece to be received at least partially within the armature tube 16. In the illustrated non-limiting example, the armature tube 16 may include an armature portion 34 and a pole portion 36, with the pole portion 36 arranged axially between the armature portion 34 and the tube flange 25. The armature portion 34 may extend axially from the closed end 24 of the armature tube 16 to a junction between the armature portion 34 and the pole portion 26. At the junction between the armature portion 34 and the pole portion 36, the armature tube 16 may extend radially outward and the pole portion 36 may extend axially from the junction to the tube flange 25. The armature tube 16 may define a change in diameter at the junction between the armature portion 34 and the pole portion 36. In the illustrated non-limiting example, the pole portion 36 may define an increased diameter compared to the armature portion 34.

In the illustrated non-limiting example, the armature portion 36 may include the plurality of dimples 28 arranged circumferentially around the inner surface 26 at a predefined axial location along the armature portion. In the illustrated non-limiting example, the armature tube 16 includes six dimples 28 spaced in equal intervals circumferentially around the inner surface 26. In some non-limiting examples, the armature tube 16 may include more or less than six dimples 28.

FIG. 9 illustrates one non-limiting shape of the dimples 28. As described herein, the axial ends of the dimples 28 may define a boat-like shape. In other words, the axial ends of the dimples 28 may be shaped like a quarter sphere with a half cylinder extending axially between the two quarter spheres. This general shape of the dimples 28 may aid in forcing debris away from and around the dimples 28 to prevent clogging contaminants between the armature 18 and the inner surface 26 of the armature tube 16. Further, the radius if curvature defined by the dimples 28 may determine a contact area between the inner surface 26 and the armature 18. Thus, the radius of curvature defined by the dimples 28 may be designed to achieve a predetermined contact area between the inner surface 26 and the armature 18.

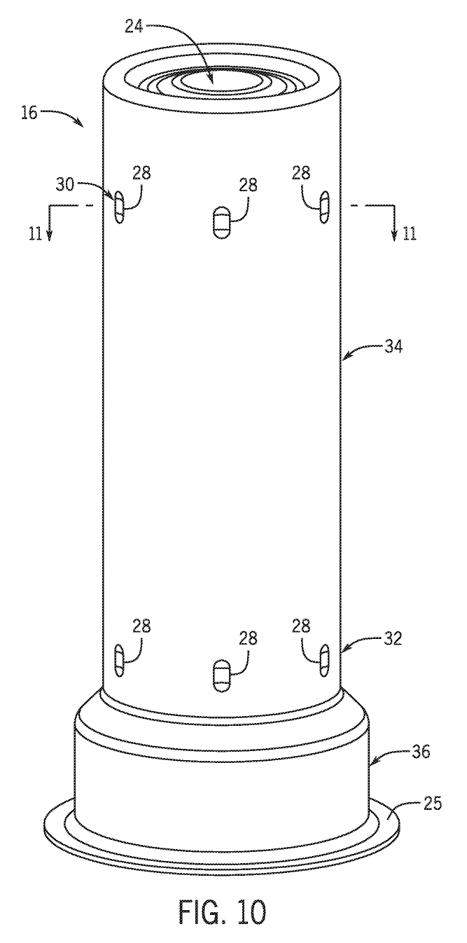

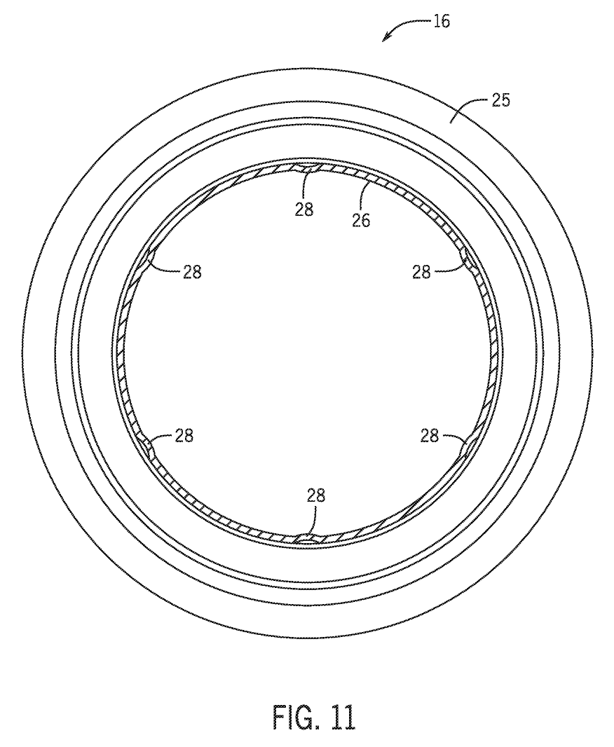

In some non-limiting examples, the axial lengths of the armature portion 34 and the pole portion 36 may be designed to accommodate a particular armature and pole piece within a solenoid. For example, FIGS. 10-13 illustrate different configurations of the armature tube 16 according to aspects of the present disclosure. In the non-limiting example of FIGS. 10 and 11, the armature portion 34 defines a greater axial length than the configuration of FIG. 7. In addition, the armature portion 34 includes a first set of dimples 30 and a second set of dimples 32 axially separated from the first set of dimples 30. The first set of dimples 30 include a first plurality of axially aligned, circumferentially spaced dimples, which are arranged adjacent to the closed end 24. The second set of dimples 32 include a second plurality of axially aligned, circumferentially spaced dimples, which are arranged adjacent to the junction between the armature portion 34 and the pole portion 36.

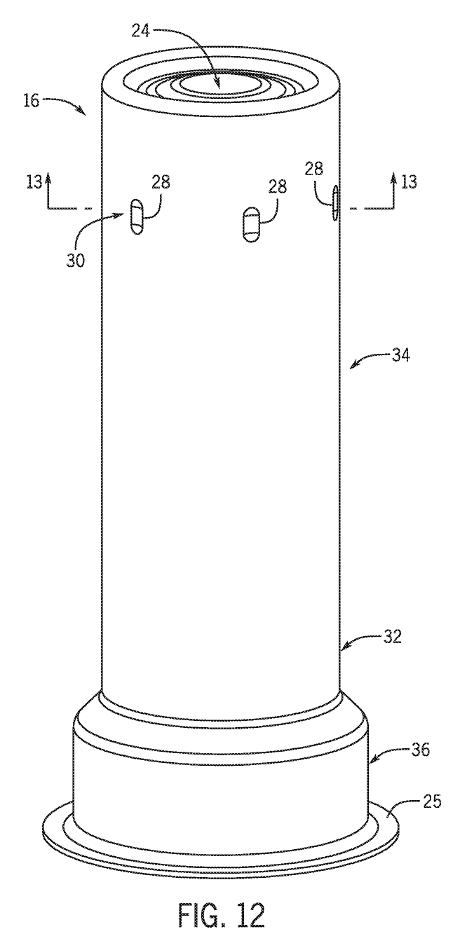

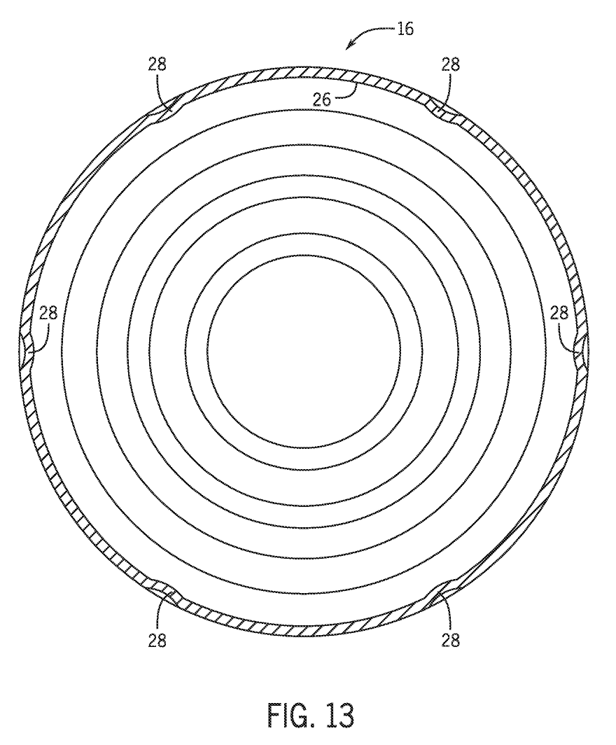

Similar to FIGS. 10 and 11, in the non-limiting example of FIGS. 12 and 13, the armature portion 34 defines a greater axial length than the configuration of FIG. 7. However, the armature portion 34 may only include the first set of dimples 30 arranged adjacent to the closed end 24. The arrangement, number, and location of the dimples 28 along the armature portion 34 may be based on one or more of the stroke of the armature 18, the desired hysteresis performance, the desired durability of the armature 18 and the armature tube 16, and/or the geometric design of the armature 18.

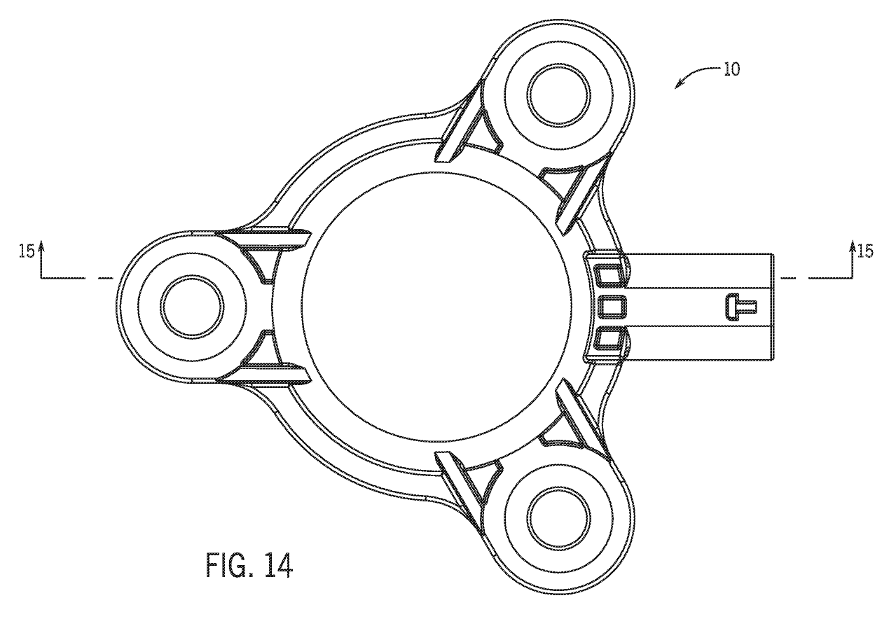

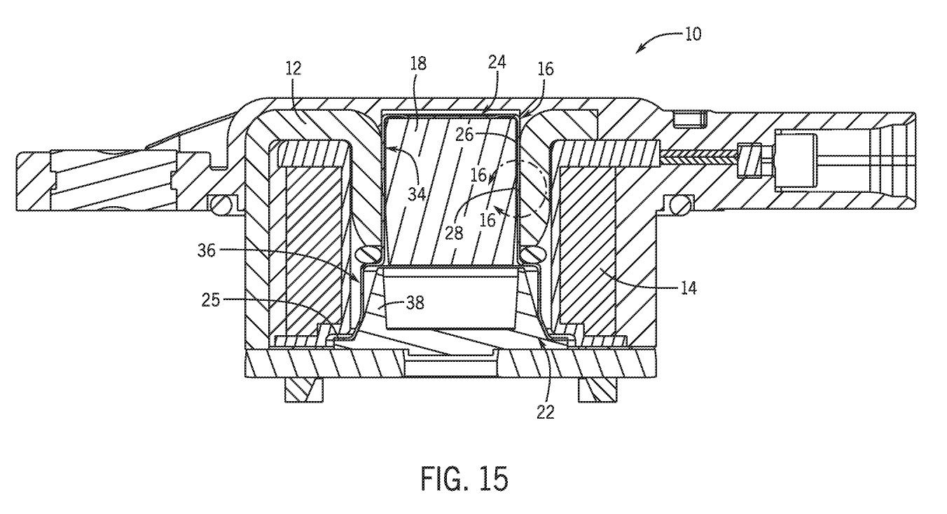

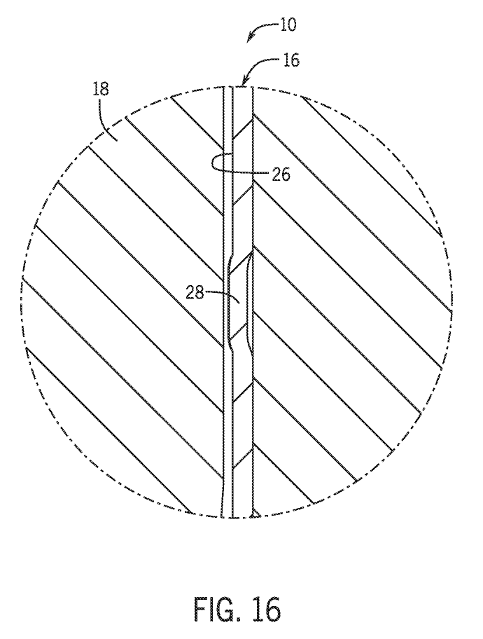

FIGS. 14-16 illustrate one non-limiting example of the solenoid 10 including the armature tube 16 of FIG. 7 installed therein. In the illustrated non-limiting example, the solenoid 10 may include the housing 12, the wire coil 14, the armature tube 16, the armature 18, and a pole piece 38. The pole portion 36 of the armature tube 16 may at least partially receive the pole piece 38 therein. In addition, the armature tube 16 may aid in concentrically aligning the housing 12, the armature 18, and the pole piece 38.

In operation, when a current is applied to the wire coil 14, the armature 18 may move axially in a predetermined direction and a predetermined stroke (i.e., axial displacement). The arrangement of the dimples 28 may be such that the armature 18 is in engagement with the dimples 28 over the entire stroke of the armature 18. In this way, for example, the dimples 28 may maintain concentric alignment and the air gap between the armature 18 and the inner surface 26 of the armature tube 16 during operation of the solenoid 10. In some non-limiting applications, the armature tube 16 may include a fluid (e.g., oil) therein during actuation of the armature 18. As described herein, the shape of the dimples 28 may aid in deflecting debris or contaminants in the fluid around the dimples 28 to allow the debris or contaminants to flow around the dimples 28, rather than become lodged or stuck on the dimples 28.

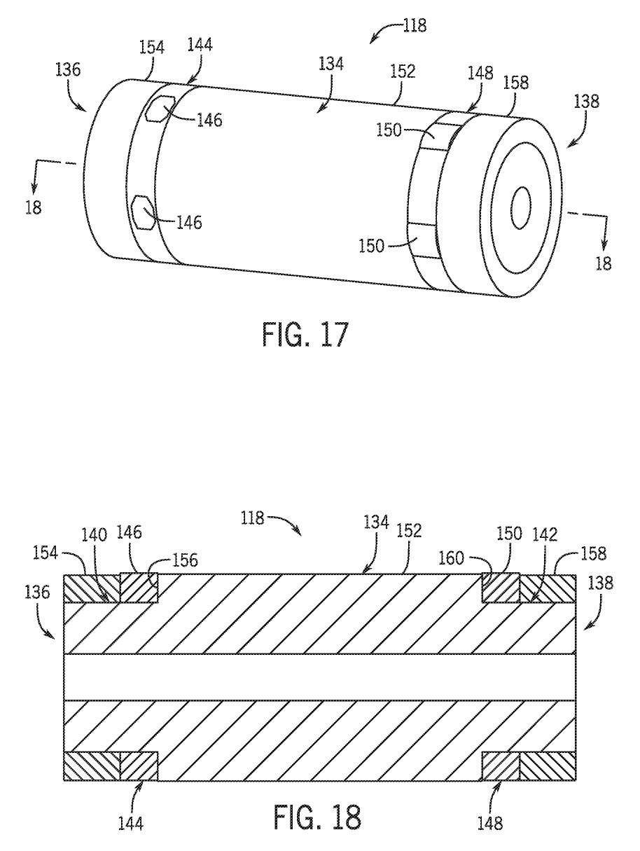

In some non-limiting examples, the armature tube 16 may not include the plurality of dimples 28 and the inner tube surface 26 may define a generally uninterrupted profile. In some non-limiting examples, alignment features may be arranged on an armature within a solenoid. For example, as illustrated in FIGS. 17-18, an armature 118 may include a unitary (i.e., one-piece) armature body 134 that defines a generally cylindrical shape. The unitary armature body 134 may include a first end 36, an axially opposing second end 138, a first radially recessed portion 140, and a second radially recess portion 142. The first radially recessed portion 140 may define a reduced diameter and extend axially along the unitary armature body 134 from the first end 136 to a location between the first end 136 and the second end 138. The second radially recessed portion 142 may define a reduced diameter and extend axially along the unitary armature body 134 from the second end 138 to a location between the second end 138 and the first end 136.

A first alignment ring 144 may be arranged on the first radially recessed portion 140 such that a light press fit exists therebetween to maintain concentricity with the armature 118. The first alignment ring 144 may include a first plurality of dimples 146 that extend radially outward therefrom and that are circumferentially spaced around the first alignment ring 144. A second alignment ring 148 may be arranged on the second radially recessed portion 142 such that a light press fit exists therebetween to maintain concentricity with the armature 118. The second alignment ring 148 may include a second plurality of dimples 150 that extend radially outward therefrom and that are circumferentially spaced around the second alignment ring 148. The first plurality of dimples 146 are arranged on the first alignment ring 144 such that axially aligned adjacent pairs of the first plurality of dimples 146 are spaced circumferentially to enable contaminants to pass therebetween. Similarly, the second plurality of dimples 150 are arranged on the second alignment ring 148 such that axially aligned adjacent pairs of the second plurality of dimples 150 are spaced circumferentially to enable contaminants to pass therebetween. In some non-limiting examples, the first alignment ring 144 and the second alignment ring 148 may be fabricated from a plastic material (e.g., PTFE, Rulon®, bronze, brass, stainless steel etc.).

In the illustrated non-limiting example, the first plurality of dimples 146 and the second plurality of dimples 150 may include five dimples equally spaced circumferentially therealong. In some non-limiting examples, the first plurality of dimples 146 and/or the second plurality of dimples 150 may include more or less than five dimples spaced circumferentially in any interval. In some non-limiting examples, the first alignment ring 144 and the second alignment ring 148 may be arranged on the armature 118 such that the first plurality of dimples 146 and the second plurality of dimples 150 are circumferentially aligned. In some non-limiting examples, the first alignment ring 144 and the second alignment ring 148 may be arranged on the armature 118 such that the first plurality of dimples 146 and the second plurality of dimples 150 are circumferentially offset.

When the solenoid is assembled, engagement between the inner tube surface 126 of the armature tube 16 and the first plurality of dimples 146 and the second plurality of dimples 150 may center the armature 118 within the armature tube 16. That is, the first alignment ring 144 and the second alignment ring 148 may control and maintain the concentricity of the armature 118 within the armature tube 16. Further, the radial extension of the first plurality of dimples 146 and the second plurality of dimples 150 beyond an outer surface 152 of the armature 118 may define a radial air gap or radial clearance between the armature 118 and armature tube 16. That is, a distance that the first plurality of dimples 146 and the second plurality of dimples 150 extend outwardly away from the central axis C and beyond the outer surface 152 may define the radial clearance between the armature 118 and the inner tube surface 26 of the armature tube 16.

During operation, the first plurality of dimples 146 and the second plurality of dimples 150 may provide a low-friction interference with the armature tube 16 to ensure efficient operation of the solenoid 10. Also, the geometric design of the first plurality of dimples 146 and the second plurality of dimples 150 (and the alignment rings in general) may provide superior control of the radial clearance between the armature 118 and the armature tube 16 and the concentricity of the armature 118 within the armature tube 16, when compared with convention bearing slots.

In the illustrated non-limiting example, the first alignment ring 144 may be secured to the first radially recessed portion 140 of the armature 118 by a first collar 154. The first collar 154 may be tightly press fit to the first radially recessed portion 140 of the armature 118, which secures the first alignment ring 144 between the first collar 154 and a first stop surface 156 formed in the unitary armature body 134 by the step change in diameter at the end of the first radially recessed portion 140. The second alignment ring 148 may be secured to the second radially recessed portion 142 of the armature 118 by a second collar 158. The second collar 158 may be tightly press fit to the second radially recessed portion 142 of the armature 118, which secures the second alignment ring 148 between the second collar 158 and a second stop surface 160 formed in the unitary armature body 134 by the step change in diameter at the end of the second radially recessed portion 142.

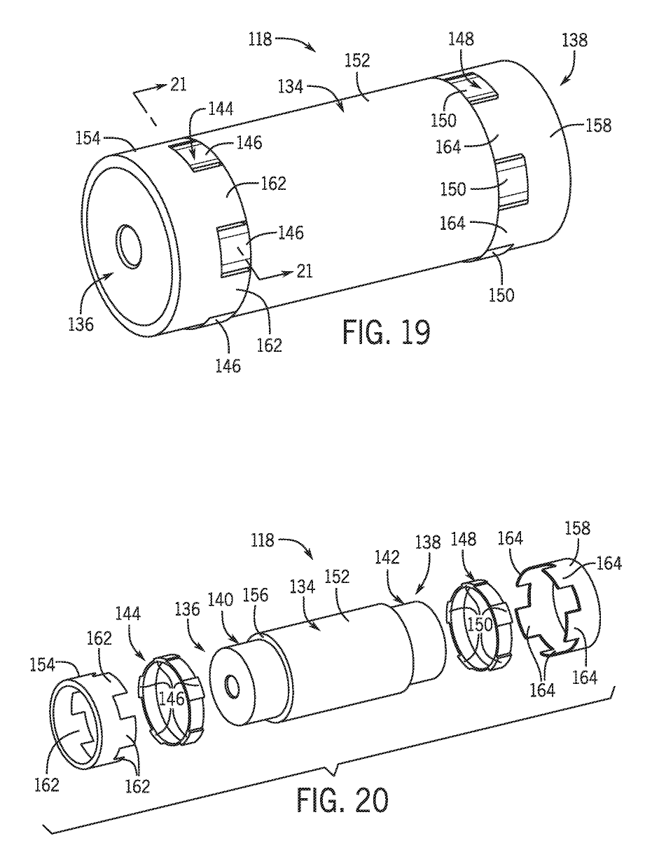

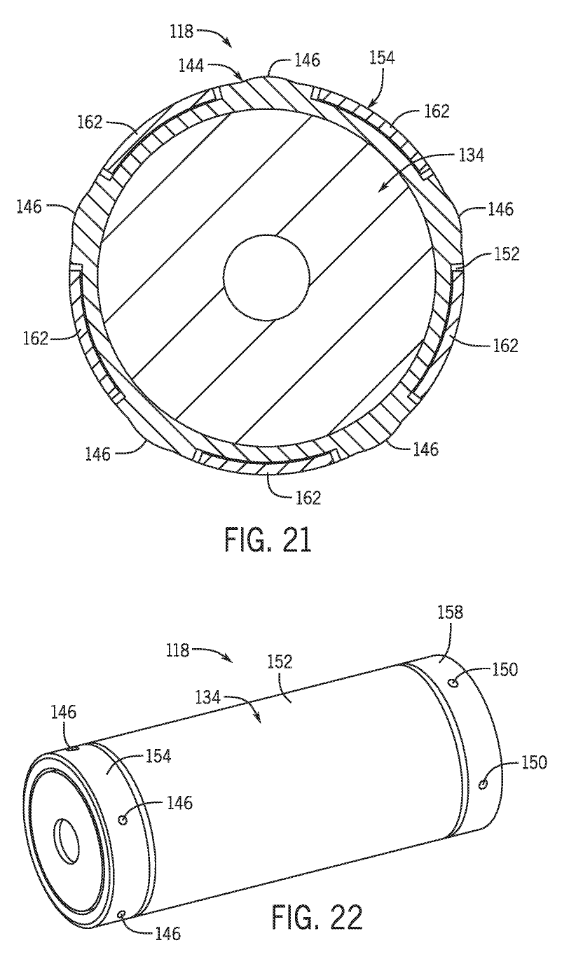

In some non-limiting examples, as illustrated in FIGS. 19-21, the first collar 154 may include a first plurality of fingers 162 that extend axially toward the first alignment ring 144. In these non-limiting examples, the first alignment ring 144 may include radially recessed portions arranged between each of the first plurality of dimples 146 to facilitate the receipt of the first plurality of fingers 162 therein. That is, when assembled, one of the first plurality of fingers 162 may be arranged between each adjacent pair of the first plurality of dimples 146. In this way, for example, the magnetic performance may be improved by removing material from the first alignment ring 144, which may be fabricated from a nonmagnetic material, and replacing the removed material with added material from the first collar 154, which may be fabricated from a magnetic material.

Similarly, the second collar 158 may include a second plurality of fingers 164 that extend axially toward the second alignment ring 148. The second alignment ring 148 may include radially recessed portions arranged between each of the second plurality of dimples 150 to facilitate the receipt of the second plurality of fingers 164 therein. That is, when assembled, one of the second plurality of fingers 164 may be arranged between each adjacent pair of the second plurality of dimples 150. In this way, for example, the magnetic performance may be improved by removing material from the second alignment ring 148, which may not be fabricated from a magnetic material, and replacing the removed material with added material from the second collar 158, which may be fabricated from a magnetic material.

In some non-limiting examples, as illustrated in FIG. 22, the first plurality of dimples 146 may be integrated onto the first collar 154 and the second plurality of dimples 150 may be integrated onto the second collar 158. In these non-limiting examples, the first alignment ring 144 and the second alignment ring 148 may not be installed on the armature 118. In these non-limiting examples, the first collar 154 and the second collar 158 may be manufactured using a cold forming process (e.g., cold forging).

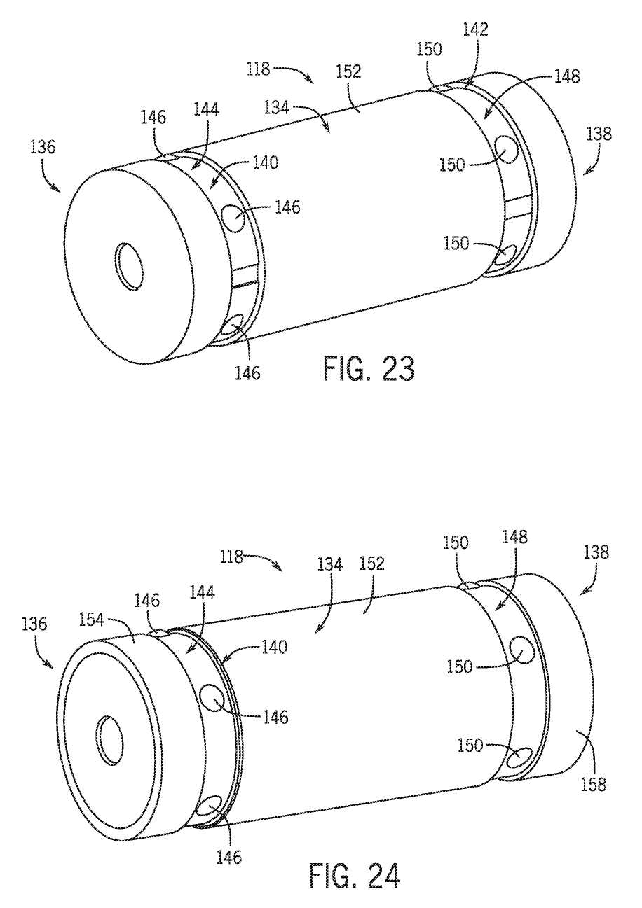

In some non-limiting examples, as illustrated FIGS. 23-26, the first alignment ring 144 and the second alignment ring 148 may be fabricated from a metal material (e.g., brass, stainless steel, etc.). In some non-limiting examples, the first alignment ring 144 and the second alignment ring 148 may be configured to snap-on, or press fit, to the armature 118 (see, e.g., FIG. 23). In these non-limiting examples, the first radially recessed portion 140 of the armature 118 may be a radially recessed notch formed adjacent to and axially inward from the first end 136 of the armature 118. The first alignment ring 144 may be configured to snap-in to the radially recessed notch and be secured therein. Similarly, the second radially recessed portion 142 of the armature 118 may be a radially recessed notch formed adjacent to and axially inward from the second end 138 of the armature 118. The second alignment ring 148 may be configured to snap-in to the radially recessed notch and be secured therein.

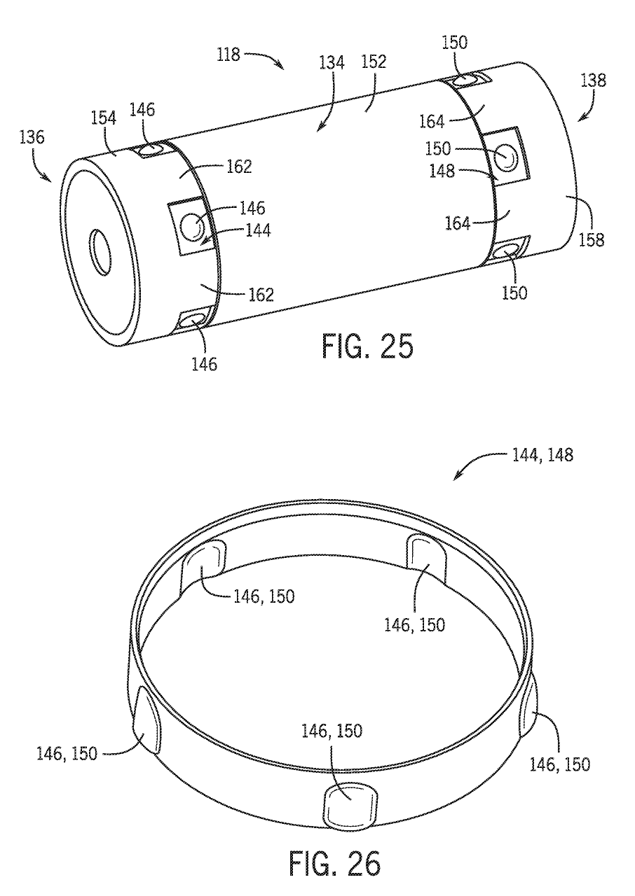

In some non-limiting examples, the metal first and second alignment rings 144 and 148 may be secured to the first and second radially recessed portions 140 and 142 using the first and second collars 154 and 158 as described above and illustrated in FIGS. 24 and 25.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

I claim:

1. A solenoid comprising:
a housing;
a wire coil arranged within the housing;
an armature tube including an inner tube surface and a plurality of dimples extending radially inward from the inner surface and arranged circumferentially around the inner tube surface; and
an armature slidably arranged within the armature tube, wherein the armature is centered within the armature tube by engagement with the plurality of dimples.

2. The solenoid of claim 1, wherein a radial clearance between an outer armature surface of the armature and the inner tube surface of the armature tube is defined by radially inward extension of the plurality of dimples.

3. The solenoid of claim 1, wherein the engagement between the armature and each of the plurality of dimples maintains concentricity between the armature and the armature tube.

4. The solenoid of claim 1, wherein axially aligned adjacent pairs of the plurality of dimples are spaced circumferentially to provide an path for contaminants move freely and maintain slidability between the armature and the armature tube.

5. The solenoid of claim 1, wherein the plurality of dimples comprise a first set of dimples and a second set of dimples.

6. The solenoid of claim 5, wherein the first set of dimples comprise a first plurality of axially aligned, circumferentially spaced dimples and the second set of dimples comprise a second plurality of axially aligned, circumferentially spaced dimples, wherein the first set of dimples is spaced axially apart from the second set of dimples.

7. The solenoid of claim 6, wherein the first set of dimples are circumferentially aligned with the second set of dimples.

8. The solenoid of claim 6, wherein the first set of dimples are circumferentially offset from the second set of dimples.

9. The solenoid of claim 1, wherein the plurality of dimples each define a quarter sphere shape at opposing axial ends there of an a half cylinder shape extending axially between the axial ends.

10. The solenoid of claim 1, wherein the armature tube includes a closed end and an axially opposed open end.

11. The solenoid of claim 10, wherein the open end of the armature tube includes a tube flange extending radially outward from the open end.

12. The solenoid of claim 11, wherein the solenoid includes a pole piece, and wherein the armature tube includes a pole portion and an armature portion, with the pole portion arranged axially between the armature portion and the tube flange.

13. The solenoid of claim 12, wherein the pole portion at least partially receives the pole piece and defines an increased diameter relative to the armature portion.

14. A solenoid tube for a solenoid, the solenoid tube comprising:
a unitary tube body defining a generally cylindrical shape and including a first end and a second end;
an inner tube surface on the unitary tube body and extending between the first end and the second end; and
a plurality of dimples formed on the inner surface and extending radially inward therefrom.

15. The solenoid of claim 14, wherein axially aligned adjacent pairs of the plurality of dimples are spaced circumferentially to enable contaminants to pass therebetween.

16. The solenoid of claim 15, wherein the plurality of dimples comprise a first set of dimples and a second set of dimples.

17. The solenoid of claim 16, wherein the first set of dimples comprise a first plurality of axially aligned, circumferentially spaced dimples and the second set of dimples comprise a second plurality of axially aligned, circumferentially spaced dimples, wherein the first set of dimples is spaced axially apart from the second set of dimples.

18. The solenoid of claim 17, wherein the first set of dimples are circumferentially aligned with the second set of dimples.

19. The solenoid of claim 17, wherein the first set of dimples are circumferentially offset from the second set of dimples.

20. The solenoid of claim 14, wherein the plurality of dimples each define a quarter sphere shape at opposing axial ends there of an a half cylinder shape extending axially between the axial ends.
